(19) United States
(12) Patent Application Publication
(10) Pub. No.: US 2011/0301758 A1
(43) Pub. Date: Dec. 8, 2011

(54) METHOD OF CONTROLLING ROBOT ARM

(75) Inventors: Ryo Nakajima, Tochigi (JP); Gentoku Fujii, Tochigi (JP)

(73) Assignee: HONDA MOTOR CO., LTD., Tokyo (JP)

(21) Appl. No.: 13/132,763

(22) PCT Filed: Oct. 7, 2009
(86) PCT No.: PCT/JP2009/005225

§ 371 Date: Aug. 23, 2011

(30) Foreign Application Priority Data
Dec. 5, 2008 (JP) 2008-310412

(51) Int. Cl. B25J 13/06

(52) U.S. Cl. 700/259; 700/264; 901/3; 901/47

(57) ABSTRACT

[SUMMARY]

[OBJECT]

Provide a method for controlling a robot arm which retrains the vibration of the arm during a switch of operating method from teaching play back control to feedback control.

[SOLUTION]

Operate robot arm by the control method comprising the following steps and the vibration of the robot arm is restrained at the time of the control change, by using a non-contact type impedance control method;

A step to move a robot arm along a course decided beforehand, the step is performed with teaching play hack control, the teaching play back control is carried out by the instruction of a program which is stored in the control department of a control unit.

A step to recognize the presence or absence of the work by a work recognition means which is provided to the arm.

A step to move the robot arm to follow the work changing the program of the control department at the same time to recognize the work, the program is changed to feedback control of the non-contact type impedance control method from teaching play back control.

### TECHNICAL FIELD

Present invention relates to a method to control a robot arm which performs work such as to screw a work in a process of producing industrial products, in particular, relates to a position controlling method of robot arms.

### BACKGROUND ART

Conventionally, in a production line, such as for automobiles, an end effector, such as a screw tightening apparatus, is attached to the finger of a multiple joints robot, and performs a screw tightening to an object (a work) of the work automatically.

When transporting a work along a production line a positional error can develop between the precision stop position of the work and individual differences in the work palette. Therefore, before the work task can be performed there needs to be a corrective adjustment between the relative position of the work and the robot.

For example, as disclosed in Prior art 1 and Prior art 2, a robot moves to the prescribed position by teaching and stops once, the reference point of the work is then recognized by a camera at the prescribed position. the variation gap from the normal position is calculated from the information of the location of the work and the robot, and the position of the robot is then revised so that a relative position becomes the normal position.

More specifically. Prior an 1 and 2 disclose a control method, which is, after the robot moves to the prescribed position by teaching, detects the size of positional gap between the robot and the work by means of a camera attached to the wrist or arm of the robot, then calculates a distance to amend the position of the robot based on the width of gap that it detected, and amends the robot position.

As mentioned above, in conventional robot control, movement to the prescribed position is carried out using a teaching play hack control taught to the robot beforehand, and the stage that amends robot's position follows the above procedure, that is a feedback control is carried out based on the information of the location of the robot and the work. Note that the PID control method is widely adopted as feedback control,

### PRIOR ART

### Patented Documents

[Prior art 1] Japanese Laid Open Patent Publication (tokkai) Heisei08-174457

[Prior art 2] Japanese Laid Open Patent Publication (tokkai) 2001-246582

### DISCLOSURE OF THE INVENTION

### Object of the Invention

In the production line, it attempts promotion of efficiency by shortening a tact time. On a production line, the aim is to promote efficiency by shortening the time taken to perform specific actions.

The methods described in Prior art 1 and 2, that is, the robot moves to the prescribed position and stops once, then recognizes the reference point of the work, next calculates a gap from the normal position from the information of the location of the work and the robot, and then revises the position of the robot.

There is a problem in Prior art 1 and 2, in that, since the robot must stop once, it takes a time to effect the final positional amendment.

In order to shorten the time to finalize the amendment of the position to the work of the robot, the inventors of the present application examined the control method of the robot.

That is when it recognizes a work during an operation by the teaching play back control, change to feedback control immediately, without the robot stopping once before performing an operation to amend the position of the robot, and carry out an operation to amend the position of the robot in one contiguous motion.

During an operation by the teaching play back control, always ensure the presence or absence of the work using a camera, and, when the work is recognized, changes to feedback control immediately, then, carry out an operation to amend the position of the robot while always confirming the positional gaps between the positions of the robot and the reference point of the works with a camera.

However, when the PID control method is adopted as the above described feedback control, and the change to the PID control from the teaching play back control is made suddenly, vibration that is unnecessary for the arm of the robot will increase, because the direction of movement from the taught operation suddenly changes.

Also when the robot oscillates, not only the precision of the positional amendment deteriorates, but also the parts such as the screws which are gripped in the end effector may drop or the life of the joint of the robot might shorten.

On the other hand, if attempts are made to restrain the vibration, the time taken until the arm settles at the work position becomes longer, in other words, the position amendment time becomes longer, so it may not actually achieve the desired time shortening.

Herein, it is conceivable to perform feedback control in the operation of the robot from the beginning without performing teaching play back control. However, in real production conditions, it is difficult to always catch a work with a camera due to the angle of field of the camera or the working environment.

The object of the present invention is to offer a robot control method. In this control method, change from teaching play back control to feedback control during an operation, and restrain the vibration of the arm of the robot.

As a result, it is possible to shorten the time required for the positional amendment.

### Means of Solving the Problem

In order to solve the above-mentioned problems, a control method of a robot arm provided with an end effector on the tip, comprising;

A step to move robot arms along a course decided beforehand, the step is performed with teaching play hack control, the teaching play back control is carried out by the instructions of a program which is stored in the control department of a control unit.

A step to recognize the presence or absence of the work by a work recognition means which is provided to the arm.

A step to move the robot arm following the work, changing the program of the control department at the same time to recognize the work, the program is changed from teaching play hack control to a feedback control of the non-contact type impedance control method.

Preferably, the work recognition means is a camera, and the work is recognized based on an image photographed by the camera.

### Effect of the Invention

In the present invention, apply a non-contact type impedance control method as feedback control, when changing the control method to feedback control from teaching play back control. The vibration is thereby restrained and makes it possible to obtain a reduction in the required time.

### SIMPLE EXPLANATION OF THE DRAWINGS

FIG. 1 A figure of system construction of the robot concerning the present invention.

FIG. 2 A flow chart of the robot control concerning the present invention.

FIG. 3 A flow chart of the control program concerning the present invention.

FIG. 4 A graph showing the actual survey data example using the non-contact type impedance control method concerning the present invention.

FIG. 5 A graph showing the actual survey data example using the PID control method.

### PREFERRED EMBODIMENT OF THE INVENTION

Best embodiment of the present invention is explained to the attached drawings.

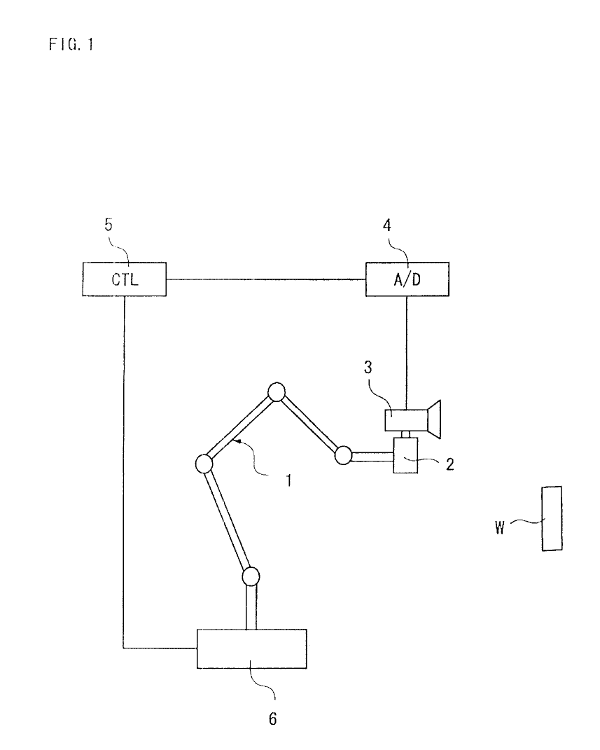

FIG. 1 is a figure of system construction of the robot concerning the present invention, a work W stands still in the predetermined position, and a robotic system R is positioned apart from the work W.

The robotic system R is comprised with a robot arm 1 of multiple joints attached to robot base 6 pivotably, an end effector 2 attached to the tip of robot arm 1, a camera 3 for the work detection as the work recognition means located in the vicinity of end effector 2, and a control unit comprising image processing component 4 and control department 5.

The robot arm 1 and the control unit are connected, and the robot arm 1 works based on the signal from the control unit.

A program is stored in control department 5 of the control unit. This program consists of the following steps.

A step which moves a robot arm along a course decided beforehand by a teaching play back control while confirming the presence or absence of work W with camera 3, a step which changes to feedback control from teaching play back control when the work W is recognized with camera 3, and a step which moves robot arms 1 by feedback control while confirming a relative position of end effector 2 to work W with camera 3.

Herein, explain the operation of the robot arm of the present invention.

At first, when the robot arm 1 receives the signal from the control department, the robot arm I moves along the course taught by teaching play back control.

The teaching play back control of this time is positioning.

Also, during transfer of robot arm 1, an image is acquired by camera 3, and it is confirmed whether the work W is in the image or not.

And when the work W is not in the image. continuously move the robot arm 1 along the course taught by teaching play back control.

The pattern matching method can be used to ensure (determine) the presence or absence of work Win the image, this method compares the image stored in the processing component 4 beforehand with the image acquired.

When the work W is confirmed in the image, the teaching play back control method is replaced by the feedback control of the non-contact type impedance control method.

In the feedback control, carry out the control basing on a position of the end effector 2 to the work W.

Specifically, calculate a position of the end effector 2 in image processing component 4, using the coordinates in space of the image which is acquired with camera 3, move the robot arm 1 to amend a position of the end effector 2 for an aim position (a reference point) corresponding to the work W.

Herein, the coordinate origin of the image space can become the aim position of the end effector 2 corresponding to the work W.

In the step of the feedback control. consecutively, the acquisition of the image is carried out by the camera 3.

And, detect a gap between a position of the end effector 2 and the aim position, then continue transfer of the robot arm 1 until the gap disappears.

Regarding the work recognition means, as well as camera 3 of the present embodiment mode, a laser sensor, an ultrasonic sensor or others which recognize location information of the end effector without contact can be use.

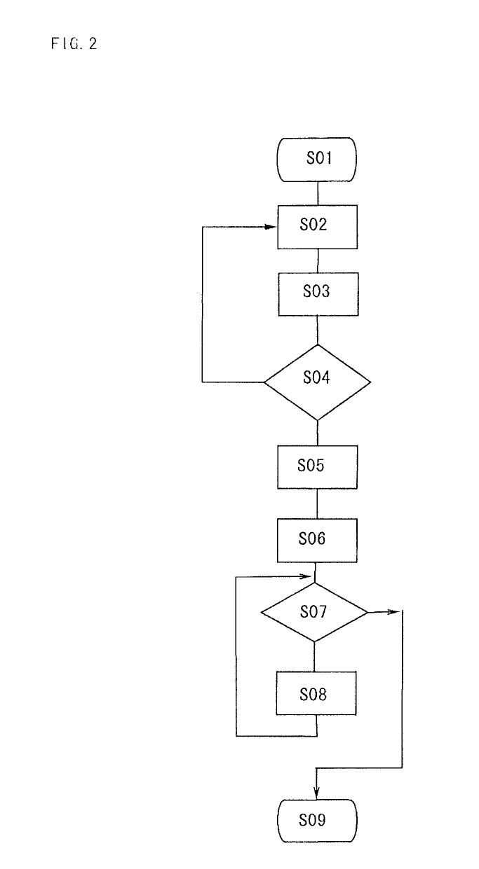

FIG. 2 is a flow chart of the robot control concerning the present invention. In the present invention, when a program of control department 5 starts (S01), an operation of robot arms 1 starts (S02). this operation is controlled by teaching play back control, and the teaching play hack control is based on an operation (a locomotive plan) that is taught to a robot by either online or off-line methods beforehand.

Then take an image with camera 3 (S03), determine whether it detects the work W memorized beforehand (S04), and when the work W is not detected by camera 3, come back to step S02, continue the operation that was taught again.

And when the work W is detected by camera 3 (S04), the control unit changes the control system to feedback control as the non-contact type impedance control method (S05). Then the image acquisition with camera 3 is carried out (S06), determine whether a position of the end effector 2 is an aim position or not (S07). When it slips off from the aim position, perform an operation to amend a position to the aim position by feedback control (S08).

When the end effector is located in the aim position in step S07, finish the feedback control and carry out the work to work W.

Herein, explain the non-contact type impedance control method which is used as above described feedback control.

The impedance control method implement a desirable impedance in the end effector of the robot with following numerical formula 1.

M_{d}\ddot{x}+D_{d}(\dot{x}−\dot{x}_{d})+K_{d}(x−x_{d})=F [formula 1]

In the numerical formula 1, Md, Dd, and Kd represent a virtual mass, a virtual viscosity, and a virtual elasticity respectively, x, xd represent a position of the end effector of the robot and an aim position, F represents an external force to act on the end effector of the robot.

Further, the virtual elasticity, the virtual viscosity and the virtual mass are set on the software of the control unit to be provided as desirable motion properties.

Conventionally, it uses a contact type impedance control method as an impedance control method, that is, it measures an external force with a sensor attached to the end effector of the robot, feeds hack the value into the control unit, then obtains the desirable motion properties.

On the other hand. when controlling a position of the end effector before performing the work to the work, it cannot make the end effector come into contact with a work directly.

Then, in the present invention, adopt the non-contact type impedance control method. That is instead of the robot coming into contact with work W, measure the distance between the position of the end effector 2 of the robot and the aim position of work W by a work recognition means (camera 3), and provide virtual external force to the end effector 2 assuming that the end effector 2 came into contact with work W, then control so that desirable motion properties are provided. In the above, the distance is a quantity of virtual contact of the end effector 2 and the work W.

Specifically, calculate a virtual external force to end effector 2 by multiplying the predetermined fixed number and the distance, and control the robot arm 1 by setting other impedance parameters (the virtual mass/virtual viscosity/virtual elasticity).

That is, apply numerical formula 1 to the x-axis direction of the coordinate of the image space, the virtual external force F is represented as follows. (here, assume the aim position as the origin (d=0) of image coordinates in space)

F=λx (λ is constant) [formula 2]

Thus, it can transform numerical formula 1 as follows.

\ddot{x}={(λ−K_{d})x−D_{d}\dot{x}}/M_{d} [formula 3]

Herein, measure a real speed of the x-axis direction as speed of the end effector and adopt this measured value in the above formula, and set an impedance parameter for the acceleration of the above formula which becomes an aimed value, that is, to set an impedance parameter for the robot arm 1 so that it does not oscillate.

In the embodiment, the virtual external force F is calculated by multiplying the predetermined fixed number and the distance, it is possible to use the distance which is a variable number.

Also, It can use a numerical value set by a prior test beforehand as an impedance parameter, further still, it is possible to vary the impedance parameter according to a movement state of the end effector 2 working by feedback control.

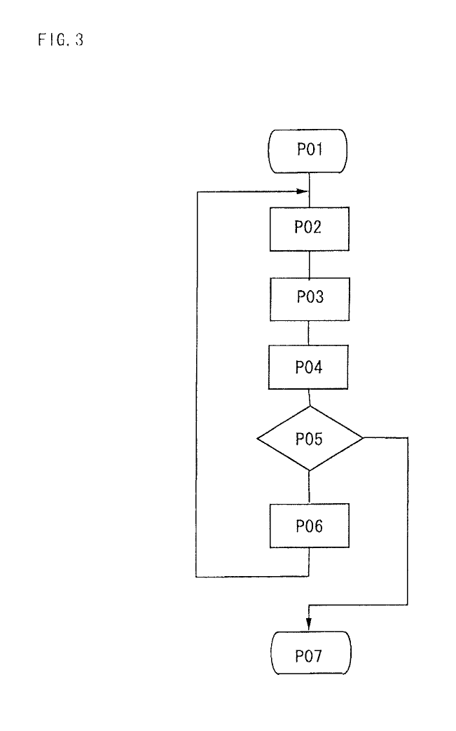

FIG. 3 is a flow chart of the control program concerning the present invention.

When a feedback control program using the non-contact type impedance control method starts in step P01 (previous step S05), the speed of the end effector 2 is calculated from an operation of robot arms 1 in control department 5 in step P02, and an image of work W is acquired by camera 3 in step P03.

Then, in step P04, based on the acquired image, calculate a position of the end effector 2 of the robot corresponding to the aim position of work W as a coordinate of display (image space) in the image processing component 4.

In step P05, determine whether or not the calculated position of the end effector 2 is an aim position, and when it is an aim position, in step P07, finish the feedback control of the non-contact type impedance control method, and start the work to the work W.

In step P05, when a gap exists between the end effector 2 and the aim position, in step P06, substitute the virtual external force F by the calculated position of the end effector 2 and the calculated speed of the end effector 2 to formula 1, and control the operation of the robot arms 1.

And come back to step P02 again, in step P04, repeat these steps until the position of the end effector 2 becomes the aim position.

As mentioned above, such as the case in which the operation of the robot arm is changing to feedback control from teaching play back control, an experiment result of the case that adopted the non-contact type impedance control method and the PID control method as a feedback control is shown below.

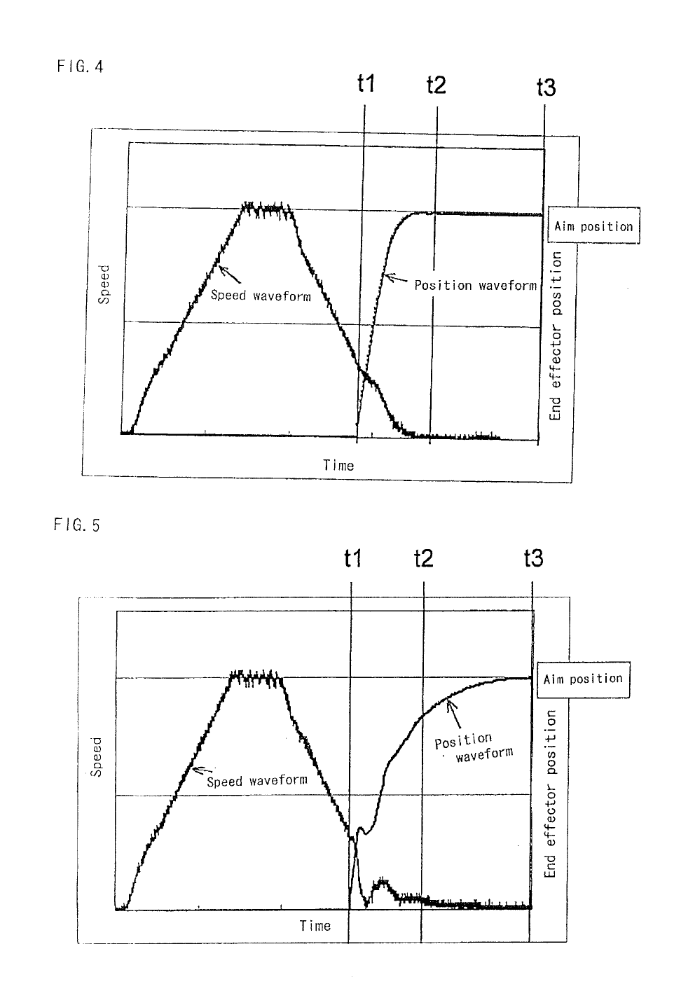

FIG. 4 is a graph showing the actual survey data example using the non-contact type impedance control method concerning the present invention.

After time 0, the robot arm starts an operation by teaching play back control, locomotive speed rises to a constant value, then, timing t1 on the way of slowdown, the work is recognized by the camera, the control method is changed to non-contact type impedance control method as a feedback control.

In the present embodiment that applied the non-contact type impedance control method, the end effector arrived to the aim position at timing t2, and referring with a table of a locomotive speed and a position of the end effector 2 after timing t1, it is observed that most of the vibration does not grow and it moves relatively smoothly.

FIG. 5 is a graph showing the actual survey data example using the PID control method, and the actual survey data is a locomotive speed and a position of the end effector.

After time 0, the robot arm starts an operation by teaching play back control, then, timing t1 on the way of slowdown, the work is recognized by the camera, the control method is replaced to PID control method, herein the axial scale of FIG. 5 is the same as FIG. 4.

In the embodiment applied the PID control method, referring to a table of a locomotive speed and a position of the end effector after timing t1, a peak is seen just after t1, and it is recognized that vibration grows to the arm right after changing the control method, also the arrival time t3 to the aim position of the end effector is greater than t2.

That is, in the PID control method, the vibration occurs (the peak of graph) when the control method is replaced to PID control, further still the convergence time (position amendment time) is long, too.

On the other hand, in the present invention adapting the sight feedback control, vibration does not occur and a convergence time is shortened in comparison with a comparative example.

### DESCRIPTION OF THE NUMERALS

I claim:

1. A control method of a robot arm provided with an end effector on the tip, comprising;
A step to move robot arms along a course decided beforehand, the step is performed with teaching play back control, the teaching play back control is carried out by the instruction of program which is stored in a control department of a control unit.
A step to recognize the presence or absence of the work by a work recognition means which is provided to the arm.
A step to move a robot arm following the work changing the program of the control department at the same time to recognize the work, the program is changed to feedback control of the non-contact type impedance control method from teaching play back control.

2. A control method of a robot arm according to claim 1, the work recognition means is a camera, and the work is recognized based on an image photographed by the camera.
